(19) United States
(12) Patent Application Publication
(10) Pub. No.: US 2024/0171466 A1
(43) Pub. Date: May 23, 2024

(54) DYNAMICALLY HARMONIZING A MANAGEMENT CONFIGURATION IN A CLOUD ENVIRONMENT

(71) Applicant: International Business Machines Corporation, Armonk, NY (US)

(72) Inventors: Malarvizhi Kandasamy, Bangalore (IN); Sudheesh S. Kairali, Kozhikode (IN); Sarbajit K. Rakshit, Kolkata (IN)

(21) Appl. No.: 18/056,364

(22) Filed: Nov. 17, 2022

(51) Int. Cl. H04L 41/0895; H04L 43/04

(52) U.S. Cl. CPC H04L 41/0895; H04L 43/04

(57) ABSTRACT

Embodiments of the present invention provide an approach for dynamically harmonizing a management configuration of a cloud environment in a cloud environment based on policy or best practices updates. Specially, the system and method provide for an automatically evolving Infrastructure as Code (IaC) based on policy, best practices changes, and a recommendation service to assist in updating IaC configuration code in order to prevent a potential service request failure.

### TECHNICAL FIELD

The present invention relates to managing a cloud environment, and more specifically to embodiments for dynamically harmonizing a management configuration of a cloud environment based on policy or best practices updates.

### BACKGROUND

Information Technology (IT) infrastructure is a critical part of many business operations, and failure of IT infrastructure can have dire effects on business operations. Many methods have been advanced to improve reliability of business applications. For example, hardware has been developed with redundant components so that the impact of a single hardware failure is masked. Applications have been made with regional redundancy and with the ability to restore themselves in the event of a crash. However, as applications have moved from being hosted by customer-owned hardware to cloud-hosted environments, managing the reliability and resilience of business applications has become more difficult.

### SUMMARY

Embodiments of the present invention provide an approach for dynamically updating an Infrastructure as Code (IaC) configuration file used to manage a cloud environment based on policy or best practices updates. Specially, the system and method provide for an automatically evolving Infrastructure as Code (IaC) based on policy, best practices changes, and a recommendation service to assist in updating IaC configuration code in order to prevent a potential service request failure.

A first aspect of the present invention provides a method for dynamically harmonizing a management configuration of a cloud environment based on policy or best practices updates, comprising: identifying, by a processor, a recent policy update related to the cloud environment; analyzing, by the processor, a historical data related to a health and readiness of a set of resources and services provided in the cloud environment to identify a pattern; and correlating, by the processor, the recent policy update and the pattern to deduce an Infrastructure as Code (IaC) configuration file update recommendation based on the correlation.

A second aspect of the present invention provides a computing system for dynamically harmonizing a management configuration of a cloud environment, comprising: a processor; a memory device coupled to the processor; and a computer readable storage device coupled to the processor, wherein the storage device contains program code executable by the processor via the memory device to implement a method, the method comprising: identifying, by a processor of the computing system, a recent policy update related to the cloud environment; analyzing, by the processor, a historical data related to a health and readiness of a set of resources and services provided in the cloud environment to identify a pattern; and correlating, by the processor, the recent policy update and the pattern to deduce an Infrastructure as Code (IaC) configuration file update recommendation based on the correlation.

A third aspect of the present invention provides a computer program product for dynamically harmonizing a management configuration of a cloud environment, the computer program product comprising a computer readable storage device, and program instructions stored on the computer readable storage device, to: identify, by a processor, a recent policy update related to the cloud environment; analyze, by the processor, a historical data related to a health and readiness of a set of resources and services provided in the cloud environment to identify a pattern; and correlate, by the processor, the recent policy update and the pattern to deduce an Infrastructure as Code (IaC) configuration file update recommendation based on the correlation.

### BRIEF DESCRIPTION OF THE DRAWINGS

FIG. 1 depicts a block diagram illustrating an example of an environment for the execution of at least some of the computer code involved in performing the inventive methods, in accordance with embodiments of the present invention.

FIG. 2 depicts a block diagram of a distributed system 200 involved in performing the inventive methods, in accordance with embodiments of the present invention.

FIG. 3 depicts a block diagram of one or more components of a system environment 300 by which services provided by one or more components of an embodiment system may be offered as cloud services, in accordance with an embodiment of the present disclosure.

FIG. 4 depicts a flow chart of a method for dynamically updating an Infrastructure as Code (IaC) configuration file used to manage a cloud environment based on policy or best practices updates, in accordance with embodiments of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

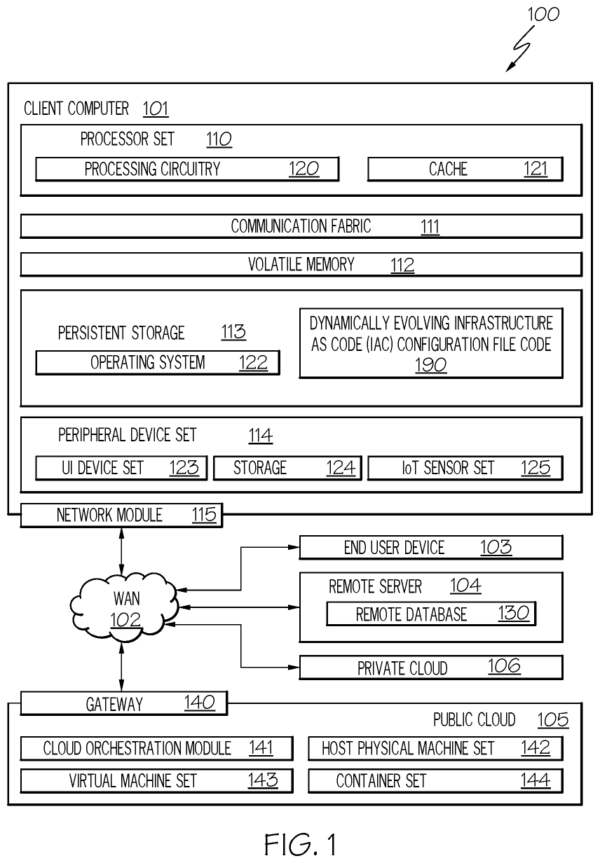

Computing environment 100 of FIG. 1 contains an example of an environment for the execution of at least some of the computer code involved in performing the inventive methods, such as dynamically evolving Infrastructure as Code (IaC) configuration file code 190 In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A cloud environment is a complex system with any number of services that are running with frequent maintenance, backup, and upgrade plans. In such systems, it becomes essential for a system administrator (or admin) to predict, plan, and schedule the workload by understanding the behavior of running services in a cloud environment in advance, so that user operations succeed without any failure. Infrastructure as code (IaC) is a process of managing and provisioning resources through machine-readable definition or configuration files, rather than physical hardware configuration or interactive configuration tools. IaC means to manage an Information Technology (IT) infrastructure (e.g., cloud environment) using programmable configuration files as code. By using cloud automation software, resources in a cloud environment can be managed by a system administrator. The cloud automation software can reduce the operating and maintenance costs and build the cloud environment without needing to manually access any infrastructure devices.

As stated, in recent years, system administrators typically use cloud automation tools to manage and provision resources (e.g., computer data centers) in a cloud environment through configuration files. As the complexity of the infrastructure and requirements grow, the size of the configuration files continue to increase. The inventors of the present invention recognize that what is missing today is intelligence these managed environments to proactively identify information (e.g., policy updates, best practices updates, etc.) which can be leveraged to increase resource reliability by dynamically implementing updates to an IaC configuration file that is used to manage to the environment.

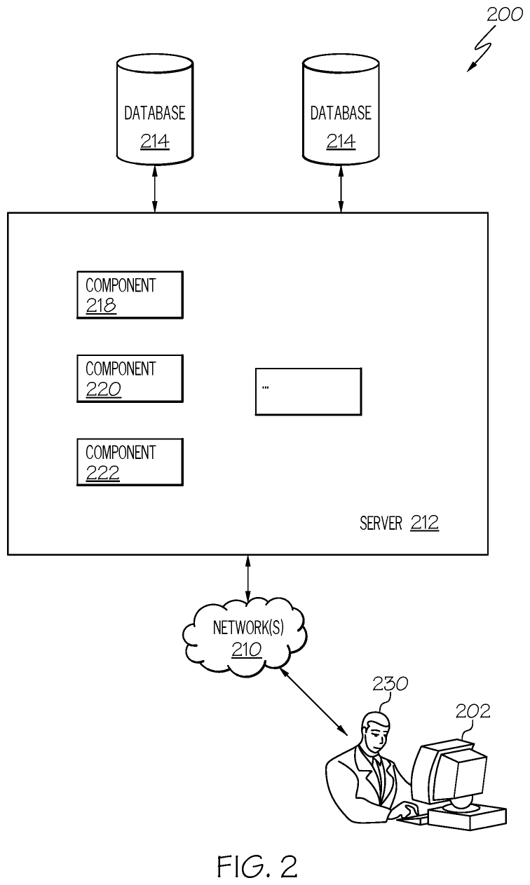

FIG. 2 depicts a block diagram of a distributed system 200 for implementing one or more of the embodiments. In the illustrated embodiment, distributed system 200 includes one or more client computing devices 202, which are configured to execute and operate a client application such as a web browser, proprietary client, or the like over one or more network(s) 210. Server 212 may be communicatively coupled with remote client computing device 202 of user 230.

In various embodiments, server 212 may be adapted to run one or more services or software applications provided by one or more of the components 218, 220, 222 of the system. In some embodiments, these services may be offered as web-based or cloud services or under a Software as a Service (SaaS) model to a user 230 of one or more client computing devices 202. User 230 operating client computing device 202 may in turn utilize one or more client applications to interact with server 212 to utilize the services provided by these components.

In the configuration depicted in FIG. 2, the software components 218, 220, and 222 of system 200 are shown as being implemented on server 212. User 230 operating the client computing devices 202 may then utilize one or more client applications to use the services provided by these components 218, 220, and 222. These components 218, 220, and 222 may be implemented in hardware, firmware, software, or combinations thereof. It should be appreciated that various different system configurations are possible, which may be different from distributed system 200. The embodiment shown in the figure is thus one example of a distributed system for implementing an embodiment system and is not intended to be limiting. Although exemplary distributed system 200 is shown with one client computing device 202, any number of client computing devices may be supported.

Network(s) 210 in distributed system 200 may be any type of network familiar to those skilled in the art that can support data communications using any of a variety of commercially available protocols, including without limitation TCP/IP (transmission control protocol/Internet protocol), SNA (systems network architecture), IPX (Internet packet exchange), AppleTalk, and the like. For example, network(s) 810 can be a local area network (LAN), such as one based on Ethernet, Token-Ring and/or the like. Network(s) 210 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 212 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 212 may be adapted to run one or more services or software applications described in the foregoing disclosure. For example, server 212 may correspond to a server for performing processing described above according to an embodiment of the present disclosure.

In some implementations, server 212 may include one or more applications to analyze and consolidate data feeds and/or event updates received from users of client computing device 202. As an example, data feeds and/or event updates may include, but are not limited to, real-time updates received from one or more third party information sources and continuous data streams, which may include real-time events related to sensor data applications, network performance measuring tools (e.g., network monitoring and traffic management applications), clickstream analysis tools, automobile traffic monitoring, and the like. Server 212 may also include one or more applications to display the data feeds and/or real-time events via one or more display devices of client computing device 202.

Distributed system 200 may also include one or more databases 214 and 216. Databases 214 and 216 may reside in a variety of locations. In an example, one or more of databases 214 and 216 may reside on a non-transitory storage medium local to (and/or resident in) server 212. Alternatively, databases 214 and 216 may be remote from server 212 and in communication with server 212 via a network-based or dedicated connection. In one set of embodiments, databases 214 and 216 may reside in a storage-area network (SAN). Similarly, any necessary files for performing the functions attributed to server 212 may be stored locally on server 212 and/or remotely, as appropriate. In one set of embodiments, databases 214 and 216 may include relational databases that are adapted to store, update, and retrieve data in response to computing language commands.

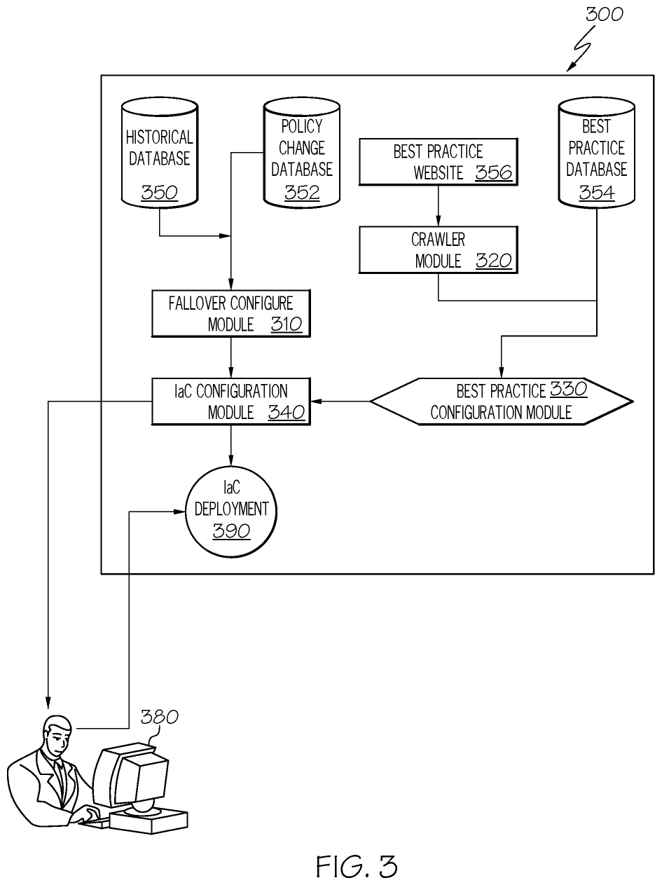

FIG. 3 depicts a block diagram of one or more components of a system environment 300 by which services provided by one or more components of an embodiment system may be offered as cloud services, in accordance with an embodiment of the present disclosure. In the illustrated embodiment, system environment 300 includes one or more client computing devices 202 (FIG. 2) that may be used by users (e.g., user 230 of FIG. 2) to interact with a cloud infrastructure reliability system 302 (or “reliability system 302”) that provides cloud services. It should be appreciated that reliability system 302 depicted in FIG. 3 may have other components than those depicted. Further, the embodiment shown in the figure is only one example of a cloud infrastructure system that may incorporate an embodiment of the invention. In some other embodiments, reliability system 302 may have more or fewer components than shown in FIG. 3, may combine two or more components, or may have a different configuration or arrangement of components. Reliability system 302 may comprise one or more computers and/or servers that may include those described above for server 212 of FIG. 2. Similarly, the system may comprise one or more databases (e.g., databases 350, 352, 354) that may include those described above (i.e., database 214 and 216) in FIG. 2.

In certain embodiments, cloud infrastructure reliability system 302 can also include infrastructure resources for providing the resources used to provide various services to users of the cloud infrastructure system. Resources in reliability system 302 may be shared by multiple users and dynamically re-allocated per demand. Additionally, resources may be allocated to users in different time zones. For example, cloud infrastructure system may enable a first set of users in a first time zone to utilize resources of the cloud infrastructure system for a specified number of hours and then enable the re-allocation of the same resources to another set of users located in a different time zone, thereby maximizing the utilization of resources.

Alternatively, or in addition, any number of internal shared services may be provided that are shared by different components or modules of reliability system 302 and by the services provided by reliability system 302. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and/or the like.

Furthermore, cloud infrastructure reliability system 302 may provide comprehensive management of cloud services (e.g., SaaS, PaaS, and/or laaS services) in the cloud infrastructure system. In an embodiment, cloud management functionality may include capabilities for provisioning, managing, and tracking a customer's subscription received by reliability system 302, and the like. As shown in FIG. 3, cloud management functionality may be provided by one or more modules, such as failover configuration module 310, crawler module 320, best practice configuration module 330, and IaC configuration change module 340. A user using a client device may interact with reliability system 302 by requesting one or more services provided by reliability system 302. The resources for providing the requested services are provisioned. Once the services and resources are provisioned, a notification of the provided service may be sent to the user on her client device.

Failover configuration module 310, best practice configuration module 330 (in communication with crawler module 320), and IaC configuration change module 340 are configured to improve the reliability and resiliency of a cloud environment supported by Infrastructure as Code (IaC) by examining the cloud infrastructure based on policy and best practice changes and, in some cases, dynamically deploying an IaC configuration file (depicted as IaC deployment 390 in FIG. 3) used to manage the environment. As described in greater detail below, the modules work together to receive information from a service, create a resource based on the received information, and provision that resource to a user so that the user operation is completed successfully without any failure. Currently, whatever is specified in IaC is executed which can result in an abrupt failure when an error occurs due to infrastructure capacity, resource quota, permission issues, and/or the like without regard to recent policy and/or best practices updates.

To that end, failover configuration module 310 is configured to monitor policy change database 352 for any updated policies related to cloud resources stored in policy change database 352. In an embodiment, policy change database 352 stores any updated policies including failback policies, default policies, location policies, and/or the like. For example, in a cloud-based private domain name service (PDNS), a global load balancer (GLB) can help improve reliability and scalability of resources based on any number of predefined policies (e.g., a failback policy, default policy, location policy, etc.). Imagine a private domain name service having private domain name resolution within a virtual private cloud (VPC). If a user specifies a particular availability pool (e.g., availability pool is us-south-1) and the availability zone is determined to be unhealthy (e.g., highly congested, and slow) due to a customer incident event (CIE) or maintenance, this can result in failing a resource request of a user.

To remedy this, an administrator (e.g., administrator 380) can make a policy change so that if a user is asking for a volume in a specific availability zone and that zone is busy or there is high congestion then an alternate zone can be automatically suggested, rather than failing the user. This policy change can be made by an administrator, for example, by setting a configuration recommendation flag contained in a policy file to true. The policy change will be reflected in policy change database 352. Failover configuration module 310 monitors for such policy changes and will carry out the policy change by recommending an alternate availability zone. To that end, a recommendation is sent to IaC configuration change module 340 so that an alternate availability zone can be used to prevent a potential failure. Otherwise, IaC would follow a configuration file use the originally specified availability zone which would likely result in a failure of the resource request. Based on the recommendation, an update reflecting the policy change is made to the IaC input configuration file to avoid any drift once resources are created. The updated file is shown below.

```
‘‘‘
resource ″ibm_dns_glb″ ″test_pdns_glb″ {
      depends_on = [ibm_dns_glb_pool.test_pdns_glb_pool]
        name = ″testglb″
        instance_id = ibm_resource_instance.test_pdns_instance.guid
        zone_id = ibm_dns_zone.test_pdns_glb_zone.zone_id
  description = ″new glb″
  ttl = 120
```

| | |
|---|---|
| enabled | = true |

```
  fallback_pool = ibm_dns_glb_pool.test_pdns_glb_pool.pool_id
  default_pools = [ibm_dns_glb_pool.test_pdns_glb_pool.pool_id]
  az_pools {
  availability_zone = ″us-south-1″
```

| | |
|---|---|
| pools | = [ibm_dns_glb_pool.test_pdns_glb_pool.pool_id] |

}
}
resource ″ibm_is_volume″ ″storage″{

```
  name = ″%s″
  profile = ″10iops-tier″
  zone = ″us-south-1″
```

}
‘‘‘

Failover configuration module 310 is further configured to monitor for a pattern of heath and readiness related to resources and services within a cloud (or, in some cases, at a multi-cloud level) using information stored in historical database 350. Historical database 350 contains health and readiness data related to the resources and services within a cloud infrastructure. Failover configuration module 310 performs a health and readiness analysis to generate any number of predictions related to the cloud infrastructure. For example, using the historical data, failover configuration module 310 can determine that a particular private Domain Name Service application goes down every 2 weeks for a Kubernetes cluster upgrade in a specific region (e.g., Dallas, Frankfurt, etc.).

Failover configuration module 310 can deduce a failover configuration required to avoid a failure by correlating the health and readiness patterns and policies (e.g., failover policies). For example, during the time when a GLB is down, when a request to provision a GLB is initiated the PDNS service can automatically set the values for recommended attributes specified in a recommended attribute list for the zone specified by user. The PDNS service can check the health status of the origin pool server value set in recommended attribute list, when it finds that what user has set is not recommended. Similarly, the best recommended time-to-live (TTL) value of the DNS is identified and recommended to the laC. The recommended update is shown in italics below.

```
...
  resource “ibm_dns_glb” “test_pdns_glb” {
name = “testglb”
  instance_id = ibm_resource_instance.test-pdns-instance.guid
zone_id = ibm_dns_zone.test-pdns-zone.zone_id
  description = “new glb”
ttl = 120
  recommended_{—}setting = [fallback_{—}pool, default_{—}pools, az_{—}pools, ttl]
fallback_pool = recommended
  default_pools = [ibm_dns_glb_pool.test-pdns-pool-nw.pool_id]
az_pools {
  availability_zone = “us-south-1”
pools = [ibm_dns_glb_pool.test-pdns-pool-nw.pool_id]
  }
}
```

Even before user requests for provisioning, failover configuration module 310 may deduce IaC changes for the failover periods for various resources and services. Failover configuration module 310 using tools like Watson can learn (using a machine learning model) to identify health and readiness patterns through analysis of historical data stored in historical database 350. (Watson is a trademark of International Business Machines in the U.S. and/or other countries). Patterns can relate to any attribute of a service or resource in a cloud infrastructure including, but not limited to, location, security, disk space/storage volume, permissions, graphics processing unit (GPU) architecture, security and compliance standard, configuration specific to an environment, etc.

For example, assume that region ‘us-south’ is shown historically to be congested during a particular day, such as a holiday. On that day, failover configuration module 310 can identify each resource and its attributes and mark the resource/attributes with region/zone that can slow down or can cause a failure. Every service can feed IaC configuration change module 340 with various recommended values, attribute combinations for every resource. From the various input combinations provided by each service, IaC configuration change module 340 can suggest attribute values. These recommendations can be enacted to make the IaC code fail safe.

In a cloud infrastructure example, failover configuration module 310 can identify all dependencies between the cloud resources. In a proper configuration file of a virtual private cloud (VSI), all the resources are highly secured with encrypted images, each endpoint is hypertext transfer protocol secure (HTTPS), and a secure sockets layer (SSL) attribute is set to ON/true. However, assume a configuration file is found to have the SSL attribute missing. Rather than specifying a default value of off/false, a recommendation can be made to IaC configuration change module 340 to update the configuration file with SSL attribute value ‘on’. Failover configuration module 310 can also suggest the provisioning, configuration management, and application deployment functionality to be secured to make the IaC deployment fail safe. The recommended updates to the configuration file are shown in italics below.

```
...
actions {
id = ″browser_check″
value = ″on″
browser_{—}cache_{—}ttl = “on”
security_{—}level=”on”
// ssl=”on”
  }
    ‘‘‘
```

In other examples, an analysis can be performed related to a storage volume, permissions, GPU architecture, security and compliance standards, and/or the like. A storage volume scenario may include a user performing an installation requiring downloading high disk images. In that case, a high storage system can be recommended. For permissions, a user with proper permissions (e.g., operator, manager, administrator) can be recommended based on operations specified in a configuration file to make it fail safe. For a security and compliance standard, resources can be compared and validated with a code risk analyzer to suggest alternate resources or recommend attribute values to be compliant with specific compliance standard (e.g., HIPAA, FedRAMP, SOC2, etc). In addition, alternate resources (e.g., for sysdig, logdna, FIM, Nessus Scanner) can be suggested to a user based on different environments (e.g., production, staging, development, etc.) if a particular service is not available, congested, or down. Alternate resources for a service can be suggested based on the security and compliance standard selected by the user. The examples above are illustrative only and not intended to be limiting. Other types of analysis related to cloud infrastructure can be performed.

At least one example described herein provides for evaluating a cloud infrastructure configuration against best practices. Best practice procedures can include rules or processes designed to avoid a potential infrastructure failure. A cloud provider may point to the published best practices pages in one or more public and/or private websites 356. An automated crawler module 320 is configured to perform a crawl search (or “crawl”) through each of the published best practices to identify the best practices documented. Alternatively or in addition, best practices can be maintained in a database, such as best practice database 354. Best practice configuration module 330 is configured to convert these identified best practices, whether published to a website and/or stored in a database, to an IaC configuration update suggestion which can be transmitted to IaC configuration change module 340. For example, the values in italics below can be identified through such a process.

```
...
actions {
  id = ″browser_check″
value = ″on″
  browser_{—}cache_{—}ttl = “off”
security_{—}level=”off”
ssl=”off”
    }
    ...
```

The best practice configuration module (e.g., module 330) can be provided by a cloud provider per resource or service. Alternatively, one can be provided through community contribution. Using the above-described method, each new deployment will be using an IaC configuration which follows best practices.

IaC configuration change module 340 is configured to provide an alert to administrator 380 and/or perform an automatic IAC deployment 390 of the best practice and/or policy-adapted IaC configuration file. In one example, when any changes in best practice or policy updates are identified, IaC code can automatically be dynamically updated, and an automatic redeployment can be performed. In another example, administrator 380 can be advised of the potential updated and, upon administrator confirmation, the deployment can be performed. IaC configuration change module 340 can provide administrator 380 notification via any means, now known or later developed.

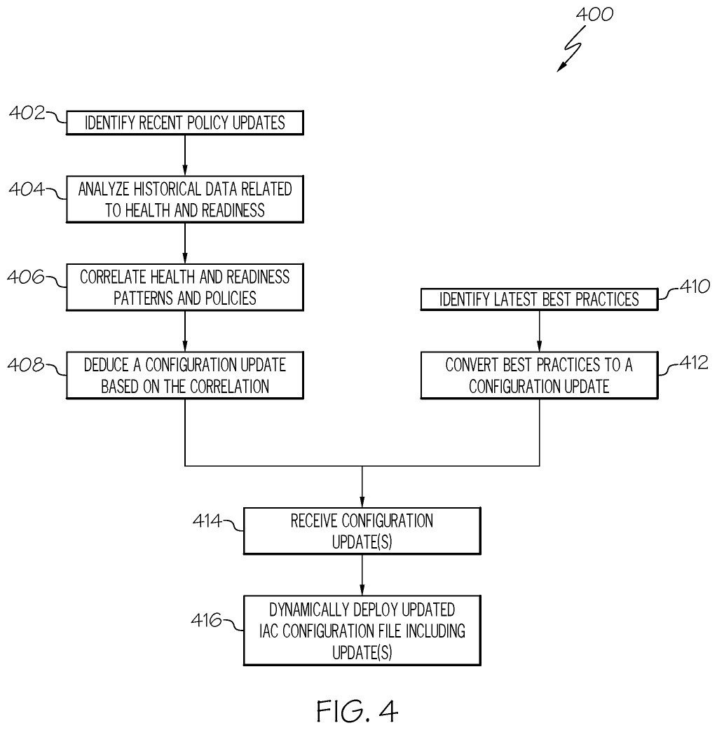

FIG. 4 depicts a flow chart of a method for dynamically updating an Infrastructure as Code (IaC) configuration file used to manage a cloud environment based on policy or best practices updates. Embodiments of the method 400 for dynamically updating an Infrastructure as Code (IaC) configuration file, in accordance with embodiments of the present invention, may begin at step 402 wherein policy configuration module 310 identifies recent policy updates related to a cloud environment. At step 404, policy configuration module 310 analyzes historical data related to a health and readiness of the resources and services provided in the cloud environment to identify any patterns. At step 406, policy configuration module 310 correlates the health and readiness patterns and policies to deduce, at step 408, an IaC configuration file update based on the correlation.

Furthermore, at step 410, crawler module 320 identifies best practices from a set of predefined published websites. At step 412, best practice configuration module 330 receives the best practices identified by crawler module 320, along with any best practices stored in a connected database and converts the best practices to an IaC configuration update. At step 414, IaC configuration change module 340 receives any configuration updates (from failover configuration module 310 and/or best practice configuration module 330). At step 416, an IaC configuration file including any updates is dynamically deployed so that when the IaC is executed the updates are included.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for dynamically harmonizing a management configuration of a cloud environment, comprising:
identifying, by a processor, a recent policy update related to the cloud environment;
analyzing, by the processor, a historical data related to a health and readiness of a set of resources and services provided in the cloud environment to identify a pattern of health and readiness related to resources and services within the cloud environment, the health and readiness data stored in historical databases;
correlating, by the processor, the recent policy update and the pattern to produce an Infrastructure as Code (IaC) configuration file update recommendation based on the correlation; and
harmonizing a management configuration of a cloud environment by dynamically updating code of an IaC configuration file automatically with an element of the IaC configuration file update recommendation, the IaC configuration file related to a process of managing and provisioning resources through machine-readable definition or configuration files.

2. The method of claim 1, further comprising generating, by the processor, a notification to an administrator related to the IaC configuration file update.

3. The method of claim 1, further comprising generating, by the processor, the IaC configuration file based on the recommendation and automatically deploying the IaC configuration file to the cloud environment.

4. The method of claim 1, further comprising performing, by the processor, a crawl search through a plurality of published documents to identify a first set of best practices and reading, by the processor, a second set of best practices from a database.

5. The method of claim 4, wherein the IaC configuration file update recommendation is generated from the group consisting of the first set and second set of best practices.

6. (canceled)

7. The method of claim 1, wherein the pattern is identified using a machine learning model.

8. A computing system for dynamically harmonizing a management configuration of a cloud environment, comprising:
a processor;
a memory device coupled to the processor; and
a computer readable storage device coupled to the processor, wherein the storage device contains program code executable by the processor via the memory device to implement a method, the method comprising:
identifying, by a processor of the computing system, a recent policy update related to the cloud environment;
analyzing, by the processor, a historical data related to a health and readiness of a set of resources and services provided in the cloud environment to identify a pattern of health and readiness related to resources and services within the cloud environment, the health and readiness data stored in historical databases;
correlating, by the processor, the recent policy update and the pattern to produce an Infrastructure as Code (IaC) configuration file update recommendation based on the correlation; and
dynamically updating code of an IaC configuration file automatically with an element of the IaC configuration file update recommendation, the IaC configuration file related to a process of managing and provisioning resources through machine-readable definition or configuration files.

9. The computing system of claim 8, further comprising generating, by the processor, a notification to an administrator related to the IaC configuration file update.

10. The computing system of claim 8, further comprising generating, by the processor, the IaC configuration file based on the recommendation and automatically deploying the IaC configuration file to the cloud environment.

11. The computing system of claim 8, further comprising performing, by the processor, a crawl search through a plurality of published documents to identify a first set of best practices and reading, by the processor, a second set of best practices from a database.

12. The computing system of claim 11, wherein the IaC configuration file update recommendation is generated from the group consisting of the first set and second set of best practices.

13. (canceled)

14. The computing system of claim 8, wherein the pattern is identified using a machine learning model.

15. A computer program product for dynamically harmonizing a management configuration of a cloud environment, the computer program product comprising a computer readable storage device, and program instructions stored on the computer readable storage device, to:
identify, by a processor, a recent policy update related to the cloud environment;
analyze, by the processor, a historical data related to a health and readiness of a set of resources and services provided in the cloud environment to identify a pattern of health and readiness related to resources and services within the cloud environment, the health and readiness data stored in historical databases;
correlate, by the processor, the recent policy update and the pattern to produce an Infrastructure as Code (IaC) configuration file update recommendation based on the correlation; and
dynamically update code of an IaC configuration file automatically with an element of the IaC configuration file update recommendation, the IaC configuration file related to a process of managing and provisioning resources through machine-readable definition or configuration files.

16. The computer program product of claim 15, further comprising program instructions stored on the computer readable storage device to generate a notification to an administrator related to the IaC configuration file update.

17. The computer program product of claim 15, further comprising program instructions stored on the computer readable storage device to generate the IaC configuration file based on the recommendation and automatically deploy the IaC configuration file to the cloud environment.

18. The computer program product of claim 15, further comprising program instructions stored on the computer readable storage device to perform a crawl search through a plurality of published documents to identify a first set of best practices and read a second set of best practices from a database.

19. The computer program product of claim 18, wherein the IaC configuration file update recommendation is generated, by the processor, from the group consisting of the first set and second set of best practices.

20. (canceled)
